(19) United States
(12) Patent Application Publication
(10) Pub. No.: US 2015/0310486 A1
(43) Pub. Date: Oct. 29, 2015

(54) DISTRIBUTING OFFERS AT THE TIME AND LOCATION OF AN EVENT

(71) Applicant: GOOGLE INC., Mountain View, CA (US)

(72) Inventors: Thomas B. Hayes, Dallas, TX (US); Weiliang Yu, Plano, TX (US)

(21) Appl. No.: 14/694,837

(22) Filed: Apr. 23, 2015

Related U.S. Application Data
(60) Provisional application No. 61/983,037, filed on Apr. 23, 2014.

(51) Int. Cl. G06Q 30/02

(52) U.S. Cl. CPC G06Q 30/0252; G06Q 30/0261; G06Q 30/0264

(57) ABSTRACT

Distributing offers to user computing devices comprises an offer distribution system employing a server configured to use user purchasing history of an event, the date and time of the event, the location, and a period in which an offer distribution campaign should be executed. The offer distribution system stores offers received from merchant systems. The offer distribution system stores an offer that is associated with an event in a database of event offers. The offer distribution system determines that a particular user has purchased a ticket to an event in the database, or otherwise become associated with an event. The offer distribution system determines that a scheduled time for providing the offer has arrived and determines the location of the user. If the user is at the event location, then the offer distribution system communicates the offer to the user.

### CROSS REFERENCE TO RELATED APPLICATION

This application claims priority to U.S. Provisional Patent Application No. 61/983,037 filed Apr. 23, 2014 and entitled “Systems, Methods, and Computer Program Products for Managing Offer Distribution,” the entire contents of which are hereby fully incorporated herein by reference.

### TECHNICAL FIELD

The present disclosure relates generally to distributing offers to user computing devices using user purchasing history related to an event, the date and time of the event, the location, and a period in which an offer distribution campaign should be executed. The methods and systems described herein permit offers to be presented to users that are relevant, cost effective, accurate, and useful.

### BACKGROUND

In conventional systems, offers may be provided to users based on the browsing or purchasing history of a user. The offers are typically provided at the time of the purchase or browsing. For example, if a user browses a web page for a particular product, an offer distribution system may provide an offer for that product to the user in the form of a pop-up advertisement on the web page. However, conventional systems are limited to providing offers during the particular purchase or browsing experience.

### SUMMARY

Techniques herein provide computer-implemented methods to communicate offers to user computer devices. An offer distribution system employs a server that is configured to receive and store event and offer information, such as a merchant identifier, an event identifier, an event location, an event date, a merchant defined date range, a merchant offer identifier, and/or merchant offer data associated with the merchant offer identifier, and at least one digital wallet account identifier. The system generates a communications message addressed to at least one user with each user address associated with a particular digital wallet, wherein each user address includes a unique digital wallet account identifier and one of a domain name, network address, or phone number. The server determines the event identifier, the event location, the event date, and the merchant date range, and compares the event date to a current date. In response to the comparison, the server stores the merchant offer data identified by the merchant offer identifier and the at least one digital wallet account identifier in a message queue for offer distribution. The server communicates the merchant offer data in the message queue in the communications message addressed to the at least one user computing device identifiable by the at least one wallet identifier.

In certain other example aspects described herein, systems and computer program products are utilized to communicate offers to user computer devices.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to provide offers associated with an event, in accordance with certain example embodiments.

FIG. 2 is a block flow diagram depicting a method to provide offers associated with an event, in accordance with certain example embodiments.

FIG. 3 is a block flow diagram depicting a method for an offer distribution system to receive and store offers from merchants, in accordance with certain example embodiments.

FIG. 4 is an example illustration of an event database, in accordance with certain example embodiments.

FIG. 5 is a block diagram depicting a computing machine and a module, in accordance with certain example embodiments.

### DETAILED DESCRIPTION OF THE EXAMPLE EMBODIMENTS

### Overview

The described technology comprises a network application communications platform for distributing merchant offers to digital wallet applications of mobile wireless devices and landline computer systems using consumer purchasing history related to a consumer event, the date and time of the event, the location, and a period in which an offer distribution campaign should be executed.

The motivation for running such an offer campaign is to provide merchants selling consumer products and services in proximity to the event to be able to reach consumers planned for attending the event with merchant offers that may entice the consumer to patronize the merchant's establishment. The event itself can provide the merchant with knowledge of what the consumer likes and dislikes. This information can be used by the merchant to better target the consumer with offers they may actually use. For example, a consumer attending a professional golf tournament is more likely to be interested in sporting apparel and equipment than a consumer attending a rock concert. Also, a father and daughter attending a theatrical performance related to a popular children's character may be interested in similar dolls from a doll store across the street. The event information could be useful to a merchant that would allow the merchant to target specific consumers at appropriate dates surrounding the event that would better enable the merchant to move his or her product.

In an example embodiment, an offer distribution system is associated with a system that manages a digital wallet for one or more users. The offer distribution system stores offers received from merchant systems. The offer distribution system stores an offer that is associated with an event in a database of event offers. The offer distribution system determines that a particular user has purchased a ticket to an event, or otherwise become associated with an event. The offer distribution system determines that a scheduled time for providing the offer has arrived and determines the location of the user. If the user is at the event location, then the offer distribution system communicates the offer to the user.

In an example embodiment, the offer distribution system receives offers from one or more merchant systems, manufacturer systems, or other suitable systems. The offer distribution system may be a function of a digital wallet system, or the offer distribution system may employ a digital wallet system for users to conduct transactions using user computing devices. For example, the offer distribution system may be a system that is attached to a digital wallet system to provide relevant offers to users.

An event may be any gathering of users that a merchant would desire to target with offers. The desirability of the event may be based on the size of the event, the demographics of the attendees of the event, the category of the event, or any other suitable characteristic of the event. Examples of events that a merchant may elect to target could include sporting events, music performances, conferences, theatrical performances, festivals, or any other suitable event.

The offer distribution system stores the received offers in a database on the offer distribution system. The offers may be provided by a merchant system or other system and associated with an event. For example, a pizza restaurant near sports arena may provide an offer to be communicated to attendees at the arena during a particular game. The offer distribution system associates the details of the offers with the time and location of the event. For example, the offer distribution system stores the offer in a database and associates the offer with a time of July 20 from 8 PM to 10 PM and a location of 100 Sports Arena Drive. The offer distribution system may additionally store a category of the event, such as “Baseball Game” or “Opera Performance.”

The offer distribution system determines that a user has purchased or received a ticket to the event. For example, the user may have used the digital wallet that is managed by the offer distribution system to purchase a ticket to the event. The offer distribution system recognizes the ticket to the event and associates the user's digital wallet account with the event. In another example, the user associates the event with the user account via a user input into the digital wallet, an offer management application, or in any suitable application. In another example, the offer distribution system extracts the event information from the social network system of the user. The offer distribution system determines that a user has purchased or received a ticket to the event in any other suitable manner.

If the offer distribution system determines that a user has purchased or received a ticket to the event, the offer distribution system associates the user account with the event. Associating the user account with the event serves to associate the user with any potential offers that are associated with the event. The association may be performed by coordinating a database of user information with the database of stored offers. The user account number may be associated with the event on the event database.

The offer distribution system determines that the time of the event is approaching or has arrived. The offer distribution system identifies the time that the offer is to be presented to the user. For example, the offer may be configured to be provided before the event occurs, such as a coupon for parking at the event site. In another example, the offer may be configured to be provided during the event, such as an offer for souvenirs from the event. In another example, the offer may be configured to be provided after the event, such as an offer for desert and coffee at a restaurant near the event location. In another example, the offer may be provided multiple times over the course of an event. Any other suitable schedule may be configured.

The offer distribution system determines that the user has arrived at the location of the event. The offer distribution system may access information in the user computing device such as a global positioning system (“GPS”) module or other location determining module. If the user is at a configured location at the appropriate time, then the offer distribution system communicates the offer to the user computing device. In an example, the offer distribution system determines that the current time is a time at which the user location should be the same as location of the event.

In certain embodiments, the offer distribution system does not require the location of the user computing device. For example, if the offer is to be sent the day before an event, then the user location is not required. If the location of the user is not required, then the offer distribution system may transmit the offer to the user computing device at the scheduled time without requesting the location of the user computing device or despite the received location of the user computing device not being in the preferred location.

If the offer distribution system determines that the user computing device is at the location of the event or other required location, then the offer distribution system communicates the offer to the user computing device. If the user computing device is not at the location of the event, then the offer distribution system may elect not to send the offer to the user computing device. In certain alternate embodiments, only one of the time or location required by the offer must be met before the offer is communicated to the user computing device.

By using and relying on the methods and systems described herein, the offer distribution system dynamically provides offers to users that are more relevant and pertinent. As such, the systems and methods described herein may be employed to allow offers from a particular merchant to be provided to users that are attending an event. For example, offers are provided to users that are at an event for goods are services that are related to the event. The offers are improved for the user in that the user receives more relevant offers. The offers are improved for the merchant systems in that the offers are being communicated to users that are more likely to use the offers. Hence, the methods and systems described herein permit offers to be presented to users that are relevant, cost effective, accurate, and useful.

### Example System Architectures

Turning now to the drawings, in which like numerals represent like (but not necessarily identical) elements throughout the figures, example embodiments are described in detail.

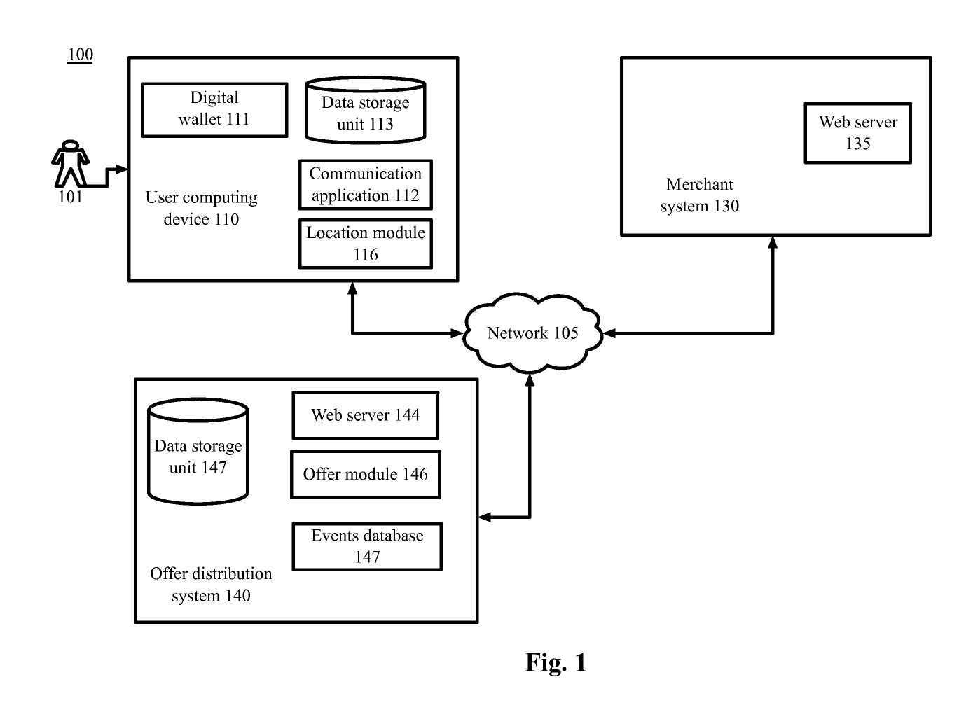

FIG. 1 is a block diagram depicting a system 100 to provide offers associated with an event, in accordance with certain example embodiments. In some embodiments, a user associated with a device must install an application and/or make a feature selection to obtain the benefits of the techniques described herein.

As depicted in FIG. 1, the system 100 includes network computing devices 110, 130, and 140 that are configured to communicate with one another via one or more networks 105 or via any suitable communication technology.

Each network 105 includes a wired or wireless telecommunication means by which network devices (including devices 110, 130, and 140) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data. Throughout the discussion of example embodiments, it should be understood that the terms “data” and “information” are used interchangeably herein to refer to text, images, audio, video, or any other form of information that can exist in a computer-based environment. The communication technology utilized by the devices 110, 130, and 140 may be similar networks to network 105 or an alternative communication technology.

Each network computing device 110, 130, and 140 includes a computing device having a communication module capable of transmitting and receiving data over the network 105 or a similar network. For example, each network device 110, 130, and 140 can include a server, desktop computer, laptop computer, tablet computer, a television with one or more processors embedded therein and/or coupled thereto, smart phone, handheld or wearable computer, personal digital assistant (“PDA”), wearable devices such as smart watches or glasses, or any other wired or wireless, processor-driven device. In the example embodiment depicted in FIG. 1, the network devices 110, 130, and 140 are operated by users 101 or consumers, merchant system operators, and offer distribution system operators, respectively.

The user 101 can use the communication application 112, which may be, for example, a web browser application or a stand-alone application, to view, download, upload, or otherwise access documents or web pages via a distributed network 105. The communication application 112 can interact with web servers or other computing devices connected to the network 105, including the web server 144 of the offer distribution system 140.

The user computing device 110 may include a digital wallet application module 111. The digital wallet application module 111 may encompass any application, hardware, software, or process the user computing device 110 may employ to assist the user 101 in completing a purchase. The digital wallet application module 111 can interact with the communication application 112 or can be embodied as a companion application of the communication application 112. As a companion application, the digital wallet application module 111 executes within the communication application 112. That is, the digital wallet application module 111 may be an application program embedded in the communication application 112. In certain embodiments a digital wallet of the user 101 may reside in a cloud computing environment, on a merchant server, or in any other environment.

The user computing device 110 also includes a data storage unit 113 accessible by the digital wallet application module 111 and the communication application 112. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory accounts or removable flash memory. In certain embodiments, the data storage unit 113 may reside in a cloud based computing system.

In an example embodiment, the GPS module 116 communicates with one or more satellites of the Global Positioning System (“GPS”) or other satellite-based location system to determine the location of the user computing device 110. In an example embodiment, the user 101 gives the offer distribution system 140 permission to identify and/or log the location of the user computing device 110 during a selected time window while the user 101 wishes to utilize the offer distribution system 140. In this example embodiment, the offer distribution system 140 periodically or continuously communicates with the GPS module 116 during applicable time periods to determine and log the location of the account creator computing device 110. In another embodiment, the location of the account creator computing device 110 is identified based on Wi-Fi signals, cellular location, or any suitable location identifying technology.

The offer distribution system 140 may include a data storage unit 147 accessible by the web server 144. The example data storage unit 147 can include one or more tangible computer-readable storage devices, or the data storage unit may be a separate system, such as, a different physical or virtual machine, or a cloud-based storage service. The offer module 146 on the offer distribution system 140 is operable to receive offers from merchant systems, select offers to appear in offer spots, log ticket purchases of a user 101, record conversions of offers, invoice merchant systems 130, present offers to users 101, and perform other suitable functions. The events database 147 on the offer distribution system 140 is operable to log event locations and times, merchant identifications, associated user account identifications, offer details, and other associated items.

The user 101 may receive offers associated with the merchant system 130. The merchant system 130 may be any physical or virtual merchant system 130 including a store, service provider, website, organization, or any other suitable entity that desires to provide offers to users 101. In an example embodiment, the merchant system 130 provides an offer to the offer distribution system 140. The offer is distributed to one or more users 101 via email, mobile ad, website advertising, or in any suitable manner. The merchant system 130 may upload an offer to the offer distribution system 140 for distribution, select an offer format from the offer distribution system 140, or in any suitable manner select or provide an offer for distribution. The web server 135 may be used to store offers, create offers, communicate with the offer distribution system 140, or perform any suitable functions.

It will be appreciated that the network connections shown are examples and other means of establishing a communications link between the computers and devices can be used. Moreover, those having ordinary skill in the art having the benefit of the present disclosure will appreciate that the merchant system 130, offer distribution system 140, and the user computing device 110 illustrated in FIG. 1 can have any of several other suitable computer system configurations. For example, a user computing device 110 embodied as a mobile phone or handheld computer may not include all the components described above.

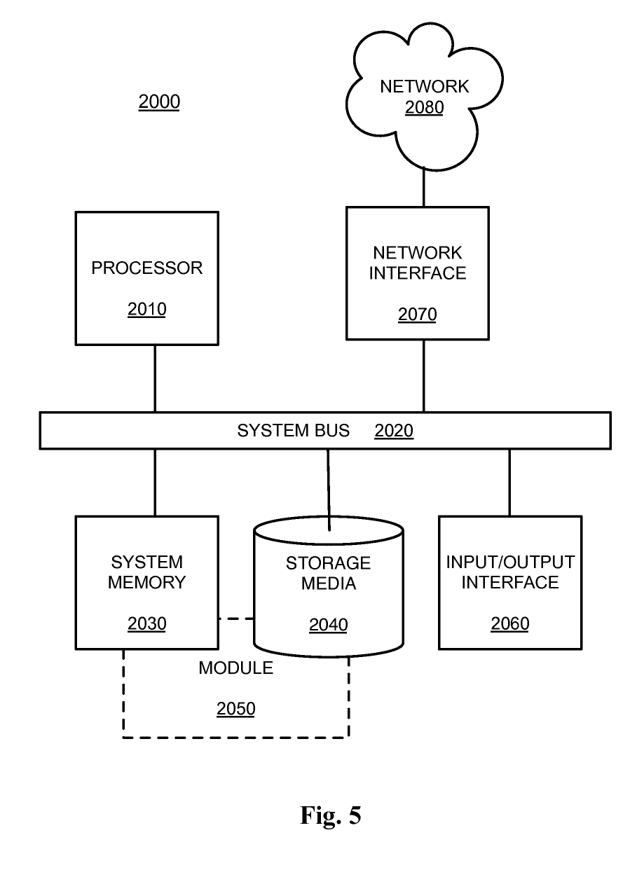

In example embodiments, the network computing devices and any other computing machines associated with the technology presented herein may be any type of computing machine such as, but not limited to, those discussed in more detail with respect to FIG. 5. Furthermore, any modules associated with any of these computing machines, such as modules described herein or any other modules (scripts, web content, software, firmware, or hardware) associated with the technology presented herein may by any of the modules discussed in more detail with respect to FIG. 5. The computing machines discussed herein may communicate with one another as well as other computer machines or communication systems over one or more networks, such as network 105. The network 105 may include any type of data or communications network, including any of the network technology discussed with respect to FIG. 5.

### Example Processes

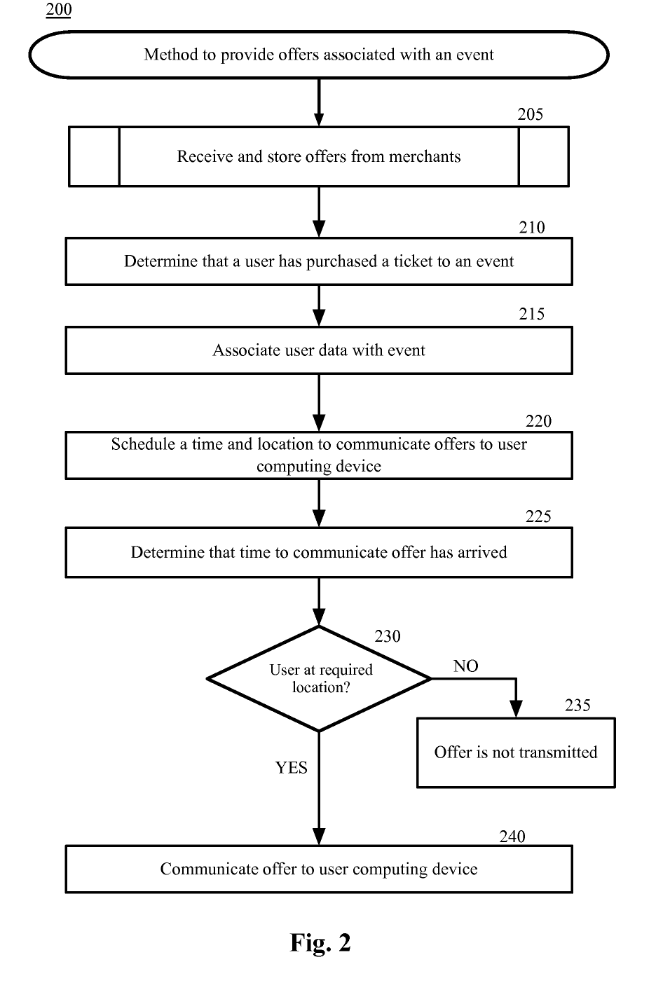

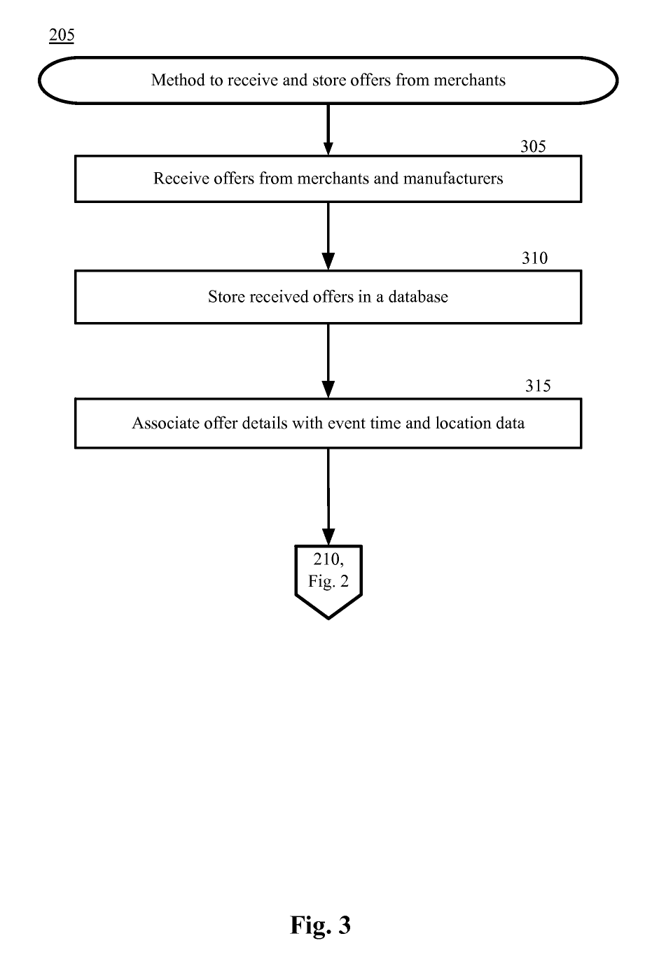

The example methods illustrated in FIGS. 2-3 are described hereinafter with respect to the components of the example operating environment 100. The example methods of FIG. 2-3 may also be performed with other systems and in other environments.

FIG. 2 is a block flow diagram depicting a method 200 to provide offers associated with an event, in accordance with certain example embodiments.

With reference to FIGS. 1 and 2, in block 205, the offer distribution system 140 receives and stores offers from merchant systems 130. The details of block 205 are described in greater detail with respect to method 205 of FIG. 3.

FIG. 3 is a block flow diagram depicting a method 205 for an offer distribution system 140 to receive and store offers from merchant systems 130, in accordance with certain example embodiments.

In block 305, the offer distribution system 140 receives offers from merchant systems 130. The offer distribution system 140 receives offers from merchant systems 130 via Internet connections over the network 105, email, text, or via any suitable communication technology. In another example, the offer distribution system 140 designs and produces the offer based on conditions, terms, requests, and other desires of the merchant system 130. In an example, the offer may be an email offer to a user 101. In another example, the offer is a location-based alert or an offer to a mobile user computing device 110. In another example, the offer is an offer to be presented on a webpage. The offer may be presentable to a user computing device 110 in any suitable format. The offers may be any form of coupon, advertisement, rebate, or other suitable offer.

In block 310, the offer distribution system 140 stores the received offers in an event database 147. The offers may be stored in categories related to the offers, such as the type of discount or reward offered, the merchant category code of the merchant system 130, the type of product associated with the offer, the expiration date of the offer, or any other suitable category. The database 147 may be stored on the web server 144 of the offer distribution system 140.

The offer distribution system 140 may receive and store a merchant system identifier, an event identifier, an event location, an event date, a merchant defined date range, a merchant offer identifier, and merchant offer data associated with the merchant offer identifier, and at least one digital wallet account identifier.

In block 315, the offer distribution system 140 associates offer details with the event time and location data. The offers may be associated with an event database 147. For example, a pizza restaurant near sports arena may provide an offer to be communicated to attendees at the arena during a particular game. The offer distribution system associates the details of the offers with the time and location of the event. For example, the offer distribution system stores the offer in a database 147 and associates the offer with a time of July 20 from 8 PM to 10 PM and a location of 100 Sports Arena Drive. The offer distribution system may additionally store a category of the event, such as “Baseball Game” or “Opera Performance.”

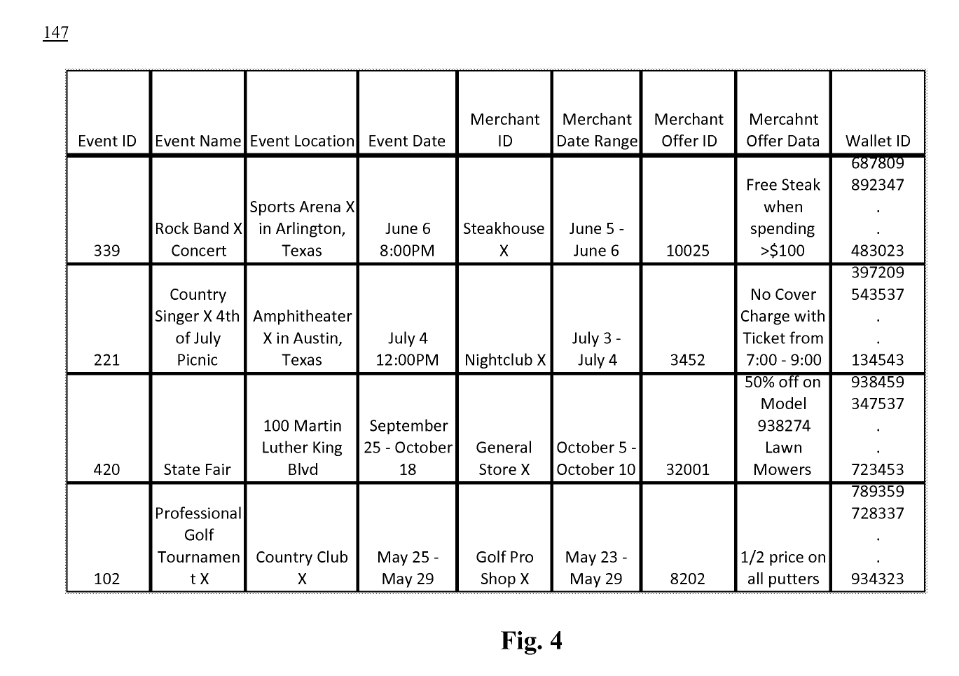

An example illustration of an event database 147 and associated offers is shown in FIG. 4. In the example database 147, events are stored with event locations, event dates, merchant systems 130 providing a related offer, the date range for which the offer is active, details of the offer, and the account numbers of the users 101 that are to receive the offer at the appointed time and location.

Returning to FIG. 3, event database 147 may store specifications for delivering the offer to the user computing device 110. For example, if the event location is Sports Arena X in Arlington Tex., then the database 147 may stored the geo-location in which the user computing device 110 must be located to receive the offer at the appointed time. For example, the location of the user computing device 110 may be required to indicate that the user computing device 110 is within the confines of the property of the Sports Arena X. In another example, the location of the user computing device 110 may be required to indicate that the user computing device 110 is within one mile of the property of the Sports Arena X. Any suitable requirements relating to the time or location of the user computing device 110 and the offer may be stored.

From block 315, the method 205 returns to block 210 of FIG. 2.

In block 210, the offer distribution system 140 determines that a user 101 has purchased or received a ticket to an event. For example, the user 101 may have used the digital wallet application module 111 that is managed by the offer distribution system 140 to purchase a ticket to the event. The offer distribution system 140 recognizes the ticket to the event and associates the user's digital wallet account with the event. The offer distribution system 140 may recognize the ticket to the event based on the receipt data in the digital wallet application module 111, based on a webpage used to purchase the ticket, based on data input by the user 101 when storing the ticket, or based on any suitable data.

In another example, the user 101 associates the event with the user digital wallet account via a user input into the digital wallet application module 111, an offer management application, or in any suitable application. In another example, the offer distribution system 140 extracts the event information from the social network system of the user 101. For example, the user 101 may post a link to the purchase of the ticket and an indication that the user 101 will be attending the event on a social network site.

In certain embodiments, the user 101 does not purchase a ticket, but provides another means of indicating that the user 101 will be attending the event. For example, the user may indicate on a social network page of the event that the user 101 will attend the event. In another example, the user 101 completes an online form indicating that the user 101 is attending the event. In another example, the user 101 accesses the website of the event or searches for the event on a map application. Any other suitable action by the user 101 indicating that the user 101 will attend the event may be noted by the offer distribution system 140.

In another example, the offer distribution system 110 interfaces third party data from an event ticketing agency wherein the third party data includes the event identifier, the event location, the event date, and the at least one wallet identifier. For example, the user 101 may provide permission with a ticketing agency to provide the offer distribution system 140 with information related to ticket purchases. The offer distribution system 140 extracts the event data to which the user 101 has purchased a ticket and associates the data with the event database 147.

In another example, the offer distribution system 110 receives and stores the merchant defined date range, the merchant offer identifier, the merchant offer data associated with the merchant offer identifier, and a merchant defined location range.

In block 215, the offer distribution system 140 associates user data with the event. The offer distribution system 140, after determining that the user 101 possesses a ticket to the event or otherwise intends to attend the event, associates the user digital wallet account number with the event. The digital wallet account number of the user 101 may be stored with one or more other digital wallet account numbers from other users. The users 101 may be stored in a file that is stored by the offer distribution system 140 to receive offers associated with the event. Associating the user account with the event serves to associate the user 101 with any potential offers that are associated with the event. The association may be performed by coordinating a database 147 of user information with the database 147 of stored offers. Alternatively, the user data may be stored on the event database 147.

In block 220, offer distribution system 140 schedules a time and location to communicate the offer to the user computing device 110. The time and location requirements for offer transmission may be transmitted to the offer distribution system 140 by the merchant system 130 at the time that the offer is originally provided to the offer distribution system 140, or at any other suitable time. The time and location requirements may be logged by the offer distribution system 140 on the event database 147, stored with the offer, or stored in any suitable location. In an example, the time requirement may be that the offer is to be transmitted while the event is happening, at the starting time of the event, at the end of the event, at any time during the event, at any time the day of the event, at any time the day before the event, after the event, or any suitable time. The time requirement may additionally specify when the offer is active. For example, the offer may be available to be redeemed while the event is happening, before the event, for the duration of the event, for one hour after the event, or any other suitable time frame. In an example, the offer is provided to the user 101 one day before the event begins, and the offer must be redeemed during the first day of a multi-day event.

In block 225, the offer distribution system 140 determines that the time to communicate the offer has arrived. The offer distribution system 140 compares the current date and time to the date and time that is specified with the offer for the offer to be presented to the user 101. If the times match, then the offer is prepared for communication to the user computing device 110.

The offer distribution system 140 generates a communications message addressed to at least one user 101 with each user address associated with a particular digital wallet account wherein each user address includes a unique digital wallet account identifier and one of a domain name, network address, or phone number of the user 101 or the user computing device 110.

The offer distribution system 130 stores the offer data identified by the merchant offer identifier and the at least one digital wallet account identifier in a message queue for offer distribution.

In block 230, the offer distribution system 140 determines if the user computing device 110 is at the event location or any other required location. For example, the offer may have a requirement that the user computing device 110 must be at the location of the event before the offer can be transmitted. In another example, the user computing device 110 must be en route to the location of the event before the offer can be transmitted. The offer distribution system 140 may access the location of the user computing device 110 by accessing the GPS module 116 of the user computing device 110 and requesting a current location. The request may be made by an Internet connection over the network 105 or via any suitable communication technology.

In certain embodiments, the offer distribution system 140 does not require the location of the user computing device 110. For example, if the offer is to be sent the day before an event, then the user location is not required. If the location of the user is not required, then the offer distribution system 140 may transmit the offer to the user computing device 110 at the scheduled time without requesting the location of the user computing device or despite the received location of the user computing device 110 not being in the preferred location. For example, the method 200 may proceed from block 220 to block 240 without awaiting or requiring the results or processing of the methods of block 225, block 230 or block 235.

If the user computing device 110 is not at the required location, then the method 200 follows the “NO” branch of block 230 to block 235. In block 235, the offer is not transmitted to the user computing device. In certain examples, the offer distribution system 140 may check the location of the user computing device 110 at a later time. For example, the offer distribution system 140 may wait one hour and then repeat the process to verify the location of the user computing device 110. The offer distribution system 140 may repeat the process for any configured amount of time or number of attempts. If the time for providing the offer elapses and the user has not arrived at the required location, then the offer distribution system 140 may end the attempt, provide the offer despite the user computing device 110 not arriving at the required location, or perform any configured task based on the requirements of the merchant system 130.

If the user computing device 110 is at the required location, then the method 200 follows the “YES” branch of block 230 to block 240.

In block 240, the offer is communicated to the user computing device 110. The offer may be communicated by an Internet connection over the network 105, via email, text, or via any suitable communication technology. The offer may provide instructions to the user 101 to redeem the offer. For example, the offer may instruct the user 101, via the user interface of the user computing device 110, that if the user purchases $50 worth of souvenirs at the gift shop of a venue, the user 101 will receive a 20% discount at the register.

The user 101 may perform any action required of the offer and/or the digital wallet application module 111 to save or redeem the offer. In an example, an emailed offer may require saving to the digital wallet application module 111 by actuating one or more virtual buttons, clicking on a link, or performing any suitable action. In another example, the user 101 may redeem an offer by displaying a barcode to a merchant system operator. Any suitable actions may be taken by the user 101 or the user computing device 110 to redeem or save the offer.

### Example Systems

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a wearable computer, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read-only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology.

Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. An offer distribution system to coordinate distribution of electronic offers to digital wallets of user computing devices operating within mobile network operator systems with event and merchant data, comprising:
a storage resource; and
a processor communicatively coupled to the storage resource, wherein the processor executes application code instructions that are stored in the storage resource to cause the system to:
receive a merchant identifier, an event identifier, an event location associated with the event identifier, an event date associated with the event identifier, a merchant offer identifier, a merchant defined date range associated with the merchant offer identifier, merchant offer data associated with the merchant offer identifier, and at least one digital wallet account identifier;
store in a database the merchant identifier, the event identifier, the event location, the event date, the merchant defined date range, the merchant offer identifier, the merchant offer data associated with the merchant offer identifier, and the at least one digital wallet account identifier;
generate a communications message addressed to at least one user with a user address associated with a particular digital wallet account, wherein each user address includes a unique one of the at least one digital wallet account identifier and one of a domain name, network address, or phone number;
identify the event identifier, a corresponding particular event location, a corresponding particular event date, and the merchant date range;
compare the particular event date to a current date to determine if the current date is the same as the particular event date;
in response to the determining that the current date is the same as the particular event date, store the merchant offer data associated with the merchant offer identifier and the at least one digital wallet account identifier in a message queue for offer distribution;
communicate the merchant offer data in the message queue in the communications message addressed to the at least one user computing device identifiable by the at least one wallet identifier; and
repeat the communication of the communications message to the at least one user computing device until the communications is successfully transmitted or the duration of the merchant defined date range has elapsed.

2. The offer distribution system of claim 1, execution of the application code instructions further causing the system to interface third party data from an event ticketing agency wherein the third party data includes the event identifier, the event location, the event date, and the at least one wallet identifier.

3. The offer distribution system of claim 1, execution of the application code instructions further causing the system to interface third party merchant data from merchants of consumer products that includes a merchant defined date range, a merchant offer identifier, and merchant offer data associated with the merchant offer identifier.

4. The offer distribution system of claim 1, execution of the application code instructions further causing the system to receive and store the merchant defined date range, the merchant offer identifier, the merchant offer data associated with the merchant offer identifier, and a merchant defined location range.

5. The offer distribution system of claim 4, execution of the application code instructions further causing the system to:
receive at least one set of location data of the user computing device;
determine if the set of location data for the user computing device defines a geographical position within the merchant defined location range; and
in response to a positive determination, communicate the communications message to the user computing device.

6. The offer distribution system of claim 5, wherein the system receives a merchant defined date range, a merchant offer identifier, merchant offer data associated with the merchant offer identifier, the event identifier, the event location, and the event date.

7. A computer-implemented method to provide offers, comprising:
receiving, using one or more computing devices, a merchant identifier, an event identifier associated with the event identifier, an event location associated with the event identifier, an event date associated with the event identifier, a merchant defined date range associated with the event identifier, a merchant offer identifier associated with the event identifier, and merchant offer data associated with the merchant offer identifier, and at least one digital wallet account identifier;
storing, using the one or more computing devices, in a database the merchant identifier, the event identifier, the event location, the event date, the merchant defined date range, the merchant offer identifier, and the merchant offer data associated with the merchant offer identifier, and the at least one digital wallet account identifier;
generating, using the one or more computing devices, a communications message addressed to the at least one user with a user address associated with a particular digital wallet account, wherein each user address includes a unique digital wallet account identifier and one of a domain name, network address, or phone number;
identifying, using the one or more computing devices, the particular event identifier, a corresponding particular event location, a corresponding event date, and the merchant date range;
in response to a comparison of the particular event date to a current date to determine if the current date is the same as the particular event date, storing, using the one or more computing devices, the merchant offer data associated with the merchant offer identifier and the at least one digital wallet account identifier in a message queue for offer distribution; and
communicating, using the one or more computing devices, the merchant offer data in the message queue in the communications message addressed to the at least one user computing device identifiable by the at least one wallet identifier.

8. The computer-implemented method of claim 7, further comprising receiving and storing, by the one or more computing devices, the merchant defined date range, the merchant offer identifier, the merchant offer data associated with the merchant offer identifier, and a merchant defined location range

9. The computer-implemented method of claim 8, further comprising:
receiving, using the one or more computing devices, at least one set of location data of the user computing device;
determining, using the one or more computing devices, if the set of location data for the user computing device defines a geographical position within the merchant defined location range; and
in response to a positive determination, communicating, using the one or more computing devices, the communications message to the user computing device.

10. The computer-implemented method of claim 7, further comprising interfacing, using the one or more computing devices, third party data from an event ticketing agency wherein the third party data includes the event identifier, the event location, the event date, and the at least one wallet identifier.

11. The computer-implemented method of claim 7, further comprising interfacing, using the one or more computing devices, third party merchant data from merchants of consumer products that includes a merchant defined date range, a merchant offer identifier, and merchant offer data associated with the merchant offer identifier.

12. The computer-implemented method of claim 7, wherein the one or more computing devices receives a merchant defined date range, a merchant offer identifier, merchant offer data associated with the merchant offer identifier, the event identifier, the event location, and the event date.

13. A computer program product, comprising:
a non-transitory computer-readable storage device having computer-executable program instructions embodied therein that when executed by a computer cause the computer to distribute offers, the computer-executable program instructions comprising:
computer-executable program instructions to receive at least one merchant identifier, at least one event identifier associated with the at least one event identifier, at least one event location associated with the at least one vent identifier, at least one event date associated with the at least one event identifier, at least one merchant defined date range associated with the at least one event identifier, at least one merchant offer identifier associated with the at least one event identifier, and merchant offer data associated with the at least one merchant offer identifier, and at least one digital wallet account identifier;
computer-executable program instructions to store in a database the at least one merchant identifier, the at least one event identifier, the at least one event location, the at least one event date, the at least one merchant defined date range, the at least one merchant offer identifier, and the at least one merchant offer data associated with the at least one merchant offer identifier, and the at least one digital wallet account identifier;
computer-executable program instructions to generate a communications message addressed to the at least one user with a user address associated with a particular digital wallet account, wherein each user address includes a unique one of the at least one digital wallet account identifier and one of a domain name, network address, or phone number;
computer-executable program instructions to identify a particular event identifier, a corresponding particular event location, a corresponding particular event date, and a corresponding particular merchant date range;
computer-executable program instructions to compare the particular event date to a current date to determine if the current date is the same as the particular event date;
computer-executable program instructions to store the merchant offer data associated with the merchant offer identifier and the at least one digital wallet account identifier in a message queue for offer distribution, in response to determining that the current date is the same as the particular event date;
computer-executable program instructions to communicate the merchant offer data in the message queue in the communications message addressed to the at least one user computing device identifiable by the at least one wallet identifier; and
computer-executable program instructions to repeat the communication of the communications message to the user computing device until the communications is successfully transmitted or the duration of the merchant defined date range has elapsed.

14. The computer program product of claim 13, further comprising computer-executable program instructions to receive and store the merchant defined date range, the merchant offer identifier, the merchant offer data associated with the merchant offer identifier, and a merchant defined location range.

15. The computer program product of claim 14, further comprising:
computer-executable program instructions to receive at least one set of location data of the user computing device;
computer-executable program instructions to determine if the set of location data for the user computing device defines a geographical position within the merchant defined location range; and
computer-executable program instructions to communicate the communications message to the user computing device in response to a positive determination.

16. The computer program product of claim 13, further comprising computer-executable program instructions to interface third party data from an event ticketing agency wherein the third party data includes the event identifier, the event location, the event date, and the at least one wallet identifier.

17. The computer program product of claim 13, further comprising computer-executable program instructions to interface third party merchant data from merchants of consumer products that includes a merchant defined date range, a merchant offer identifier, and merchant offer data associated with the merchant offer identifier.

18. The computer program product of claim 15, wherein the system receives a merchant defined date range, a merchant offer identifier, merchant offer data associated with the merchant offer identifier, the event identifier, the event location, and the event date.
